(19) United States
(12) Patent Application Publication
(10) Pub. No.: US 2026/0169490 A1
(43) Pub. Date: Jun. 18, 2026

(54) SYSTEM AND METHOD FOR ADAPTIVE CHANCE-CONSTRAINED, RISK-AWARE FLIGHT PATH OPTIMIZATION FOR AN AERIAL VEHICLE

(71) Applicant: Richard Joseph Mitchell, TAVARES, FL (US)

(72) Inventor: Richard Joseph Mitchell, TAVARES, FL (US)

(21) Appl. No.: 19/373,677

(22) Filed: Oct. 29, 2025

(51) Int. Cl. G05D 1/633; G05D 1/46; G05D 1/644; G05D 109/25

(52) U.S. Cl. CPC G05D 1/633; G05D 1/46; G05D 1/644; G05D 2109/254

(57) ABSTRACT

A control system for an unmanned aerial vehicle (UAV) provides adaptive, chance-constrained flight path optimization. A state estimation module generates a state vector and covariance matrix for the UAV. A trajectory forecasting module predicts a path and trajectory covariance for dynamic obstacles. In a synergistic feedback loop, the state estimator dynamically adjusts its process noise based on the obstacle forecast uncertainty. An adaptive receding horizon optimization module propagates these covariance matrices over a time horizon whose length is dynamically adjusted based on computed collision risk, balancing efficiency and safety. The module computes an optimized flight path by minimizing a cost function subject to a chance constraint requiring the probability of collision to remain below a predefined threshold. The system enables safe and efficient navigation by adaptively managing uncertainty.

### BACKGROUND OF THE INVENTION

### 1. Field of the Invention

The present invention relates generally to the field of autonomous navigation for unmanned aerial vehicles (UAVs). More specifically, it pertains to systems and methods for real-time flight path planning that explicitly account for and adapt to uncertainty in the vehicle's state and the predicted trajectories of dynamic obstacles.

### 2. Description of Related Art

Unmanned aerial vehicles are integral to a growing number of commercial, civil, and military applications. A critical capability for autonomous UAV operation is the ability to navigate safely and efficiently through complex, dynamic environments.

The prior art is well-developed in the foundational aspects of UAV navigation. Path planning algorithms such as A* and Rapidly-exploring Random Trees (RRTs) are widely used for finding collision-free paths in static environments. To handle the non-linear dynamics of UAVs and fuse data from multiple sensors, filtering techniques such as the Extended Kalman Filter (EKF) and Unscented Kalman Filter (UKF) are standard practice for state estimation. Furthermore, control strategies such as Model Predictive Control (MPC), also known as receding horizon control, are often used for real-time trajectory optimization.

While these conventional systems can detect obstacles and perform avoidance maneuvers, they typically operate under the assumption of certainty or handle uncertainty with simple, oversized safety margins. This leads to two significant drawbacks. First, the flight paths may be overly conservative and inefficient. Second, in scenarios where uncertainty is high, these simple safety margins may be insufficient, leading to an unacceptable risk of collision.

More advanced approaches have incorporated probabilistic frameworks, such as chance-constrained optimization, to quantify uncertainty and manage risk. These systems attempt to compute an optimal flight path that intelligently balances mission efficiency with a quantifiable level of risk. However, the prior art fails to address critical challenges related to the practical, real-time implementation of such systems in highly dynamic and unpredictable environments. A naive combination of probabilistic estimation, prediction, and chance-constrained control often results in a system that is either too computationally demanding for real-time execution on board a UAV or one that remains overly conservative because its components operate independently without synergistic feedback.

Specifically, existing systems lack a mechanism for the different sources of uncertainty to inform one another. For example, the state estimator typically operates with a fixed model of its own process noise, irrespective of the predictability of the surrounding environment. Furthermore, the computational load of the path optimizer, which is heavily dependent on the length of its prediction horizon, is typically fixed, leading to a poor trade-off between long-term safety and computational feasibility. There is therefore a need for a more advanced control system that not only uses a probabilistic framework but also incorporates adaptive mechanisms and synergistic feedback between its modules to achieve robust, efficient, and computationally tractable risk-aware navigation.

### BRIEF SUMMARY OF THE INVENTION

The present invention provides a system and method for controlling an unmanned aerial vehicle that overcomes the limitations of the prior art by introducing an adaptive, chance-constrained, risk-aware optimization framework featuring synergistic integration of its core modules. The system explicitly models, propagates, and mitigates the effects of uncertainty in a computationally efficient and robust manner.

In one embodiment, an aerial vehicle control system is provided. The system comprises a multi-sensor suite, a state and uncertainty estimation module, a probabilistic trajectory forecasting module, and an adaptive receding horizon chance-constrained optimization module. The state and uncertainty estimation module generates a state vector and an associated state covariance matrix quantifying the uncertainty in the UAV's state estimate.

The probabilistic trajectory forecasting module analyzes environmental data to predict, for each dynamic obstacle, a probabilistic forecast comprising a mean predicted trajectory and an associated trajectory covariance matrix.

A key inventive aspect is the synergistic feedback between these modules. The state and uncertainty estimation module is configured to dynamically adjust its internal model parameters, specifically its process noise covariance, based on the uncertainty of the forecasts generated by the trajectory forecasting module. When the environment is predicted to be highly uncertain, the estimator intelligently increases its own process noise, making it more responsive to new sensor measurements. This creates a robust, adaptive estimation process that is aware of the environmental context.

Another inventive aspect resides in the adaptive receding horizon chance-constrained optimization module. This module computes an optimized flight path by minimizing a multi-objective cost function subject to a chance constraint, wherein the chance constraint requires that the computed Probability of Collision remains below a predefined risk threshold. Critically, the length of the receding time horizon is not fixed; it is dynamically adjusted based on the computed collision risk. In high-risk scenarios, the horizon is lengthened to facilitate more comprehensive, safer planning, while in low-risk scenarios, it is shortened to reduce computational load, thereby achieving an optimal balance between safety and real-time performance.

The multi-objective cost function is formulated to include a specific risk cost term, namely a logarithmic barrier function. This function imposes a rapidly increasing penalty as the computed Probability of Collision approaches the predefined risk threshold, ensuring the chance constraint is strictly enforced within the optimization. This combination of synergistic feedback, an adaptive optimization horizon, and a well-defined risk cost function results in a system that generates paths that are less conservative than those based on simple safety margins, safer and more computationally efficient than prior art probabilistic planners, and robust to the challenges of real-world dynamic environments.

### BRIEF DESCRIPTION OF THE SEVERAL VIEWS OF THE DRAWING

FIG. 1 is a block diagram illustrating the high-level architecture of the aerial vehicle control system in accordance with an embodiment of the invention.

FIG. 2 is a schematic diagram illustrating an unmanned aerial vehicle incorporating the control system of FIG. 1, showing the propagation of uncertainty ellipsoids for chance-constrained planning.

FIG. 3 is a flowchart illustrating the steps of a method for adaptive chance-constrained, risk-aware flight path optimization performed by the control system, in accordance with an embodiment of the invention.

### DETAILED DESCRIPTION OF THE INVENTION

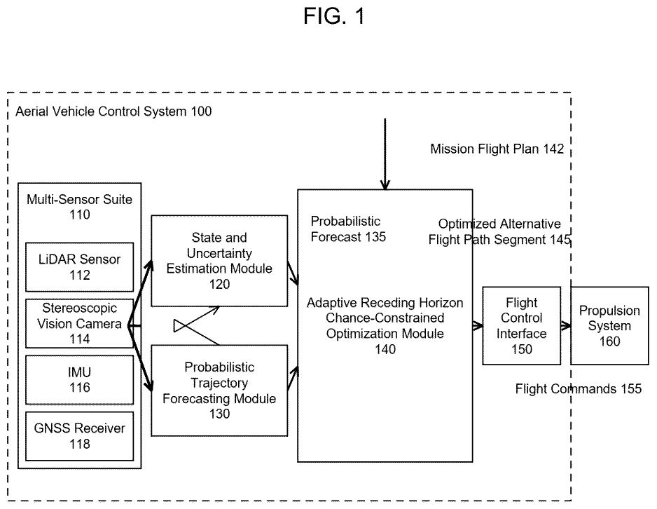

Referring now to the drawings, wherein like reference numerals designate identical or corresponding parts throughout the several views, FIG. 1 illustrates a block diagram of the aerial vehicle control system (100). The system (100) is implemented on board an unmanned aerial vehicle (UAV) to provide advanced autonomous navigation capabilities that are robust to uncertainty.

The system (100) includes a multi-sensor suite (110), which may include a LIDAR sensor (112), a stereoscopic vision camera (114), an Inertial Measurement Unit (IMU) (116), and a Global Navigation Satellite System (GNSS) receiver (118). Data from the multi-sensor suite (110) is transmitted to a state and uncertainty estimation module (120). This module (120) is a processing unit configured to fuse the disparate, noisy data streams to produce a robust estimate of the UAV's state vector x_{UAV} and an associated state covariance matrix P_{UAV}. In a preferred embodiment, the module (120) implements an Unscented Kalman Filter (UKF).

The environmental data from the multi-sensor suite (110) is also provided to a probabilistic trajectory forecasting module (130). This module (130) analyzes the data to identify and track dynamic obstacles. For each obstacle, the module (130) generates a probabilistic forecast (135) of its future trajectory, comprising a mean predicted trajectory, x_{obs}(t), and a time-varying trajectory covariance matrix, P_{obs}(t). In one embodiment, the module (130) employs a Gaussian Process Regression (GPR) model.

In a novel synergistic integration, a feedback path exists from the probabilistic trajectory forecasting module (130) to the state and uncertainty estimation module (120). The module (120) is configured to dynamically adjust a process noise covariance matrix of its Unscented Kalman Filter based on the trajectory covariance matrix P_{obs}(t) from the forecasting module (130). For instance, if the uncertainty in an obstacle's predicted trajectory is high (i.e., the determinant of P_{obs}(t) is large), the process noise of the UKF is increased. This makes the state estimator more responsive to new sensor measurements when the environment is less predictable, thereby improving the overall robustness of the system.

The core of the invention resides in the adaptive receding horizon chance-constrained optimization module (140). This module (140) receives the UAV's current state estimate (x_{UAV}, P_{UAV}), the probabilistic forecasts for all obstacles (135), and the current mission flight plan (142). The module (140) solves a constrained optimization problem over a finite time horizon, T, to compute an optimized alternative flight path segment (145).

The optimization is formulated to minimize a multi-objective cost function, Jₜₒₜₐₗ, defined as:

$${J}_{total} = {w}_{p} \cdot {J}_{path} + {w}_{e} \cdot {J}_{energy} + {w}_{r} \cdot {J}_{risk}$$

where wₚ, wₑ, wᵣ are weighting coefficients. Jₚₐₜₕ is a cost on path length, J_{energy} is a cost on control effort, and Jᵣᵢₛₖ is a risk-cost term. The risk cost is specifically formulated as a logarithmic barrier function that heavily penalizes trajectories as the computed probability of collision, P_{coll}, approaches the acceptable risk threshold, δᵣᵢₛₖ. For example, Jᵣᵢₛₖ may be proportional to −log(δᵣᵢₛₖ−P_{coll}(t)).

The optimization is subject to a chance constraint:

$${P}_{coll} ( t ) \leq {δ}_{risk} \qquad ∀ t ∈ T$$

where P_{coll}(t) is computed at each future time step by propagating the covariance matrices P_{UAV} and P_{obs} and calculating the probability of overlap between the resulting uncertainty volumes of the UAV and each obstacle.

Critically, the time horizon T is adaptive. The module (140) dynamically adjusts the length of the horizon at each optimization cycle based on the state of the system, such as the computed probability of collision. For example, if the maximum computed P_{coll}(t) over the horizon exceeds a first threshold, indicating a high-risk situation, the horizon T is increased to allow the optimizer to find a safer, longer-term solution. Conversely, if P_{coll}(t) remains below a second, lower threshold, T may be decreased to reduce the computational burden of the optimization, freeing up resources for other tasks. This adaptive horizon provides a significant advantage in computational efficiency without compromising safety.

The optimized alternative flight path segment (145) is transmitted to a flight control interface (150), which translates the path into low-level flight commands (155). These commands (155) are sent to the UAV's propulsion system (160) to execute the maneuver.

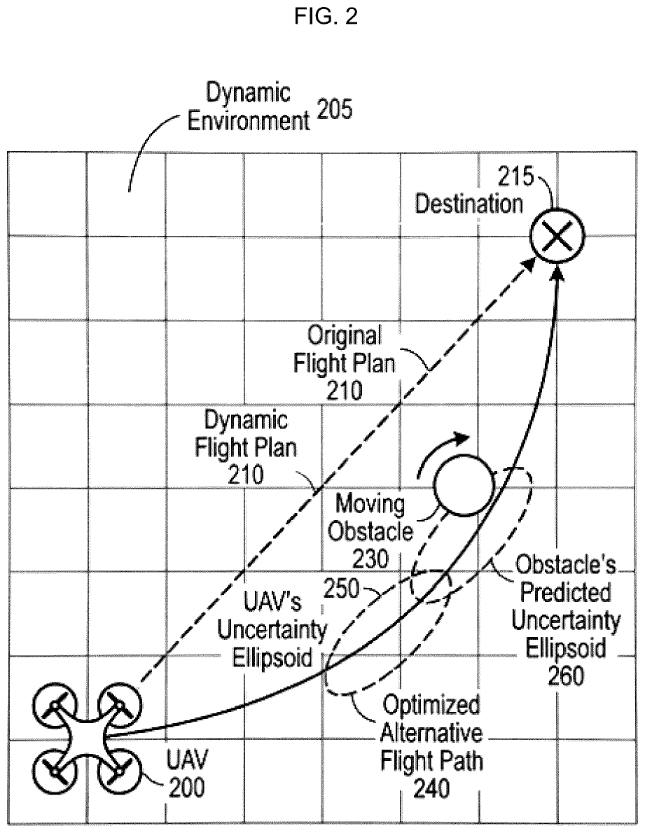

FIG. 2 illustrates the concept in a dynamic environment (205). A UAV (200) has an original flight plan (210) toward a destination (215). A moving obstacle (230) is detected. The system propagates the UAV's uncertainty ellipsoid (250) and the obstacle's predicted uncertainty ellipsoid (260) over the adaptive time horizon. The optimization module (140) computes an optimized alternative flight path (240) that ensures the probability of overlap between these ellipsoids remains below δᵣᵢₛₖ.

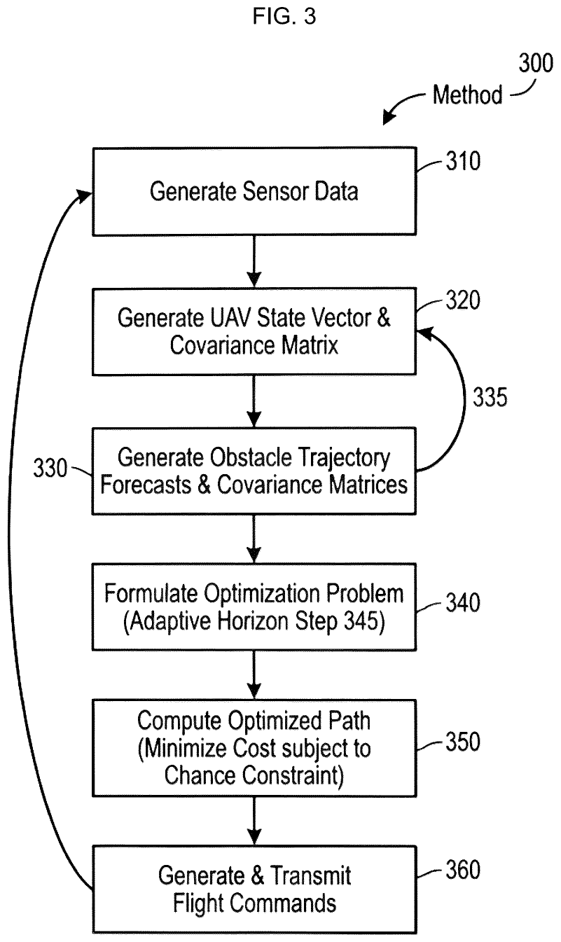

FIG. 3 is a flowchart illustrating the method (300). The method begins at step (310), where the system generates sensor data. At step (320), the state and uncertainty estimation module (120) generates the UAV's state vector and covariance matrix. At step (330), the probabilistic trajectory forecasting module (130) generates the probabilistic forecasts for obstacles. In a synergistic feedback step (335), the state estimation module (120) adjusts its internal parameters (e.g., process noise) based on the uncertainty of the forecasts from step (330). At step (340), the adaptive receding horizon chance-constrained optimization module (140) formulates the optimization problem. This includes an adaptive step (345) where the length of the planning horizon T is adjusted based on the current risk assessment. At step (350), the module (140) computes the optimized alternative flight path (145) by minimizing the multi-objective cost function subject to the chance constraint. Finally, at step (360), the flight control interface (150) generates and transmits flight commands (155) to execute the new path segment. The process then returns to step (310).

1. An aerial vehicle control system, comprising:
a. a multi-sensor suite configured to generate sensor data corresponding to a state of an aerial vehicle and an environment surrounding the aerial vehicle;
b. a state and uncertainty estimation module communicatively coupled to the multi-sensor suite, the module configured to:
i. receive the sensor data; and
ii. apply an Unscented Kalman Filter to generate a state vector and an associated state covariance matrix for the aerial vehicle, wherein the state covariance matrix quantifies an uncertainty in the state vector;
c. a probabilistic trajectory forecasting module configured to analyze the sensor data to identify one or more obstacles and to predict, for each of the one or more obstacles, a probabilistic forecast comprising a mean predicted trajectory and an associated trajectory covariance matrix;
an adaptive receding horizon chance-constrained optimization module configured to:
i. receive a current flight plan, the state vector and state covariance matrix of the aerial vehicle, and the probabilistic forecast for each of the one or more obstacles;
ii. propagate the state covariance matrix and the trajectory covariance matrix over a time horizon;
iii. compute, based on the propagated covariance matrices, a time-dependent probability of collision between the aerial vehicle and each of the one or more obstacles; and
iv. compute an optimized alternative flight path by minimizing a multi-objective cost function subject to a chance constraint, wherein the chance constraint requires that the computed probability of collision remains below a predefined risk threshold throughout the time horizon; and
d. a flight control interface configured to generate one or more flight commands based on the optimized alternative flight path and transmit the one or more flight commands to the propulsion system of the aerial vehicle;
wherein the adaptive receding horizon chance-constrained optimization module is further configured to dynamically adjust a length of the time horizon based on the computed time-dependent probability of collision; and
wherein the state and uncertainty estimation module is further configured to dynamically adjust a process noise covariance of the Unscented Kalman Filter based on the trajectory covariance matrix associated with an obstacle forecast received from the probabilistic trajectory forecasting module.

2. The system of claim 1, wherein the multi-objective cost function comprises a risk cost, and wherein the risk cost is a logarithmic barrier function that imposes a penalty that increases non-linearly as the probability of collision approaches the predefined risk threshold.

3. The system of claim 2, wherein the logarithmic barrier function is proportional to −log(δᵣᵢₛₖ−P_{coll}), where δᵣᵢₛₖ is the predefined risk threshold and P_{coll} is the computed probability of collision.

4. The system of claim 1, wherein the length of the time horizon is increased in response to the computed probability of collision exceeding a first predetermined value and decreased in response to the computed probability of collision being below a second predetermined value.

5. The system of claim 1, wherein the probabilistic trajectory forecasting module is configured to apply a Gaussian Process Regression model to an observed motion history of an obstacle to predict the probabilistic forecast.

6. The system of claim 1, wherein the adaptive receding horizon chance-constrained optimization module is configured to compute the probability of collision by calculating a probability of geometric overlap between an N-sigma uncertainty ellipsoid derived from the state covariance matrix and an N-sigma uncertainty ellipsoid derived from the trajectory covariance matrix.

7. The system of claim 1, wherein the multi-sensor suite comprises a LIDAR sensor, a stereoscopic vision camera, an Inertial Measurement Unit (IMU), and a GNSS receiver.

8. A method for controlling an aerial vehicle, the method comprising:
a. generating, via a multi-sensor suite, sensor data corresponding to a state of an aerial vehicle and an environment surrounding the aerial vehicle;
b. generating, by a state and uncertainty estimation module applying an Unscented Kalman Filter, a state vector and an associated state covariance matrix for the aerial vehicle based on the sensor data;
c. predicting, by a probabilistic trajectory forecasting module, a probabilistic forecast for each of one or more identified obstacles, the probabilistic forecast comprising a mean predicted trajectory and an associated trajectory covariance matrix;
d. dynamically adjusting, by the state and uncertainty estimation module, a process noise covariance of the Unscented Kalman Filter based on the trajectory covariance matrix received from the probabilistic trajectory forecasting module;
computing, by an adaptive receding horizon chance-constrained optimization module, an optimized alternative flight path by:
i. dynamically adjusting a length of a time horizon based on a computed time-dependent probability of collision;
ii. propagating the state covariance matrix and the trajectory covariance matrix over the adjusted time horizon;
iii. computing, based on the propagated covariance matrices, the time-dependent probability of collision; and
iv. minimizing a multi-objective cost function subject to a chance constraint requiring that the computed probability of collision remains below a predefined risk threshold; and
e. transmitting, via a flight control interface, one or more flight commands to the propulsion system of the aerial vehicle to cause the aerial vehicle to follow the optimized alternative flight path.

9. The method of claim 8, wherein minimizing the multi-objective cost function comprises minimizing a logarithmic barrier risk cost that is a function of the computed probability of collision.

10. The method of claim 8, wherein dynamically adjusting the length of the time horizon comprises increasing the length of the time horizon when the probability of collision exceeds a first predetermined value and decreasing the length of the time horizon when the probability of collision is below a second predetermined value.

11. The method of claim 8, wherein predicting the probabilistic forecast comprises applying a Gaussian Process Regression model to an observed motion history of an obstacle.

12. The method of claim 8, wherein computing the probability of collision comprises calculating a probability of geometric overlap between uncertainty ellipsoids derived from the propagated covariance matrices.

13. A non-transitory computer-readable medium having instructions stored thereon that, when executed by a processor, cause the processor to perform operations for controlling an aerial vehicle, the operations comprising:
a. receiving sensor data generated by a multi-sensor suite;
b. generating a state vector and an associated state covariance matrix for the aerial vehicle by applying an Unscented Kalman Filter to the sensor data;
c. predicting a probabilistic forecast for each of one or more identified obstacles, the probabilistic forecast comprising a mean predicted trajectory and an associated trajectory covariance matrix;
d. dynamically adjusting a process noise covariance of the Unscented Kalman Filter based on the trajectory covariance matrix;
e. computing an optimized alternative flight path by:
i. dynamically adjusting a length of a time horizon based on a computed time-dependent probability of collision;
propagating the state covariance matrix and the trajectory covariance matrix over the adjusted time horizon;
ii. computing, based on the propagated covariance matrices, the time-dependent probability of collision; and
iii. minimizing a multi-objective cost function subject to a chance constraint requiring that the computed probability of collision remains below a predefined risk threshold; and
f. generating one or more flight commands corresponding to the optimized alternative flight path for transmission to the propulsion system of the aerial vehicle.
